(19) United States
(12) Patent Application Publication
(10) Pub. No.: US 2004/0213550 A1
(43) Pub. Date: Oct. 28, 2004

(54) Data reproducer

(76) Inventor: Tsutomu Sasaki, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/469,699

(22) PCT Filed: Mar. 13, 2002
(86) PCT No.: PCT/JP02/02387

(30) Foreign Application Priority Data
Mar. 14, 2001 (JP) 2001-72389

(51) Int. Cl. H04N 5/783

(52) U.S. Cl. 386/68; 386/69; 386/70

(57) ABSTRACT

The present invention provides an audio player comprising a memory card 1, reproduction circuit 2, microcomputer 3, DSP 4, and headphone output terminal 7. The microcomputer 3 extracts bit rate information from audio data in reproduction of audio data. Every time the microcomputer extracts the bit rate information, the microcomputer feeds a frequency control signal to the DSP 4 corresponding to the bit rate information. The DSP 4 performs a specified signal processing at a frequency corresponding to the frequency control signal fed from the microcomputer 3. This suppresses the shortening of a cell life due to useless power consumption.

### TECHNICAL FIELD

The present invention relates to data reproduction devices for reproducing digital data recorded on a memory, performing a specified signal processing for the digital data, and outputting the processed data.

### BACKGROUND ART

In recent years portable audio players have been in wide use which are adapted to reproduce digital audio data recorded on a memory such as a memory card or a flash memory.

The operating frequency of the audio players of this type is pre-set at a great value for enabling reproduction of the audio data having the highest bit rate (the number of bits recorded per second) from among audio data to be reproduced, and signals are always processed as specified at the operating frequency having this value. The signals are processed at such high frequency as described, whereby all of the audio data to be reproduced can be reproduced without noise and pause of voice occurring.

However, with the conventional portable audio players, the signals are always processed at the constant high frequency regardless of a bit rate of the audio data, so that electric power is wasted in reproduction of audio data having a low bit rate wherein signals are not required to be processed at such high frequency, hence the problem of reducing the life of a cell serving as a power source of the player due to the wasted electric power.

An object of the present invention is to provide a data reproduction device capable of suppressing the shortening of a cell life due to useless power consumption.

### DISCLOSURE OF THE INVENTION

A data reproduction device embodying the present invention comprises:

data reproducing means for reproducing digital data recorded on a memory,

signal processing means for performing a specified signal processing for the reproduced digital data at an operating speed corresponding to a speed control signal fed from outside and outputting the data,

information extracting means for extracting recording speed information from the reproduced digital data, and

speed control means for preparing the speed control signal based on the extracted recording speed information and feeding the speed control signal to the signal processing means.

With the data reproduction device of the present invention, the data reproducing means starts to reproduce data, starting to extract the information of recording speed (bit rate) which is included in the reproduced digital data, to feed to the signal processing means the speed control signal corresponding to the extracted recording speed information. The signal processing means performs the specified signal processing for the reproduced digital data at the operating speed corresponding to the fed speed control signal.

The signal is processed at the operating speed corresponding to the data recording speed, so that the signal will not be processed at such a high operating speed as is not required for reproduction of data having a low recording speed. This reduces useless power consumption in reproduction of data having a lower recording speed.

Stated specifically, as recording speed becomes higher, the speed control means prepares such a speed control signal as makes higher the operating speed of the signal processing means, while as recording speed becomes lower, the speed control means prepares such a speed control signal as makes lower the operating speed of the signal processing means.

As the recording speed of data becomes higher, the operating speed of the signal processing means needs to be increased, while as the recording speed of data becomes lower, the operating speed of the signal processing means needs to be decreased. According to the specific construction described, the speed control means varies the speed control signal as described above and feeds the resulting signal to the signal processing means.

Further stated specifically, the data reproduction device comprises storing means for storing a reference value providing reference in preparing the speed control signal as for the recording speed. The speed control means compares the extracted recording speed information with the reference value and prepares the speed control signal based on the comparison result.

As stated above, as the recording speed of data becomes higher, the operating speed of the signal processing means needs to be increased, while as the recording speed of data becomes lower, the operating speed of the signal processing means needs to be decreased. According to the specific construction, the reference value of the recording speed is pre-stored in the storing means, the reference value is compared with the extracted recording speed information, and the speed control signal is prepared based on the comparison result.

Stated more specifically, the speed control means comprises:

clock feeding means for feeding a clock signal to the signal processing means, and

commanding means for commanding the clock feeding means to feed a clock signal having a frequency corresponding to the recording speed information.

Stated specifically in reproduction of data, the commanding means of the speed control means commands the clock feeding means to feed a clock signal having a frequency corresponding to the extracted recording speed information, and the clock feeding means feeds the clock signal having said frequency to the signal processing means in response to the command. The signal processing means executes a specified operation at an operating speed corresponding to the fed clock signal.

Stated further specifically the digital data described is audio data, and the recording speed information is included in the digital data at a predetermined interval.

For example, audio data providing one tune includes recording speed information for each frame, each of the recording speed information is not always the same. It is likely that different recording speed information is included. In this case the operating speed of the signal processing means varies in reproduction of the audio data providing one tune.

As described above with the data reproduction device of the present invention, useless power consumption can be reduced to suppress shortening of a cell life.

### BRIEF DESCRIPTION OF THE DRAWINGS

FIG. 1 is a block diagram showing the construction of a portable audio player embodying the present invention;

FIG. 2 is a block diagram showing the construction of DSP of the audio player;

FIG. 3 is a diagram showing a signal recording format of a memory card;

FIG. 4 is a flowchart showing a control procedure of an operating frequency of a microcomputer to be executed in reproduction of audio data.

### BEST MODE OF CARRYING OUT THE INVENTION

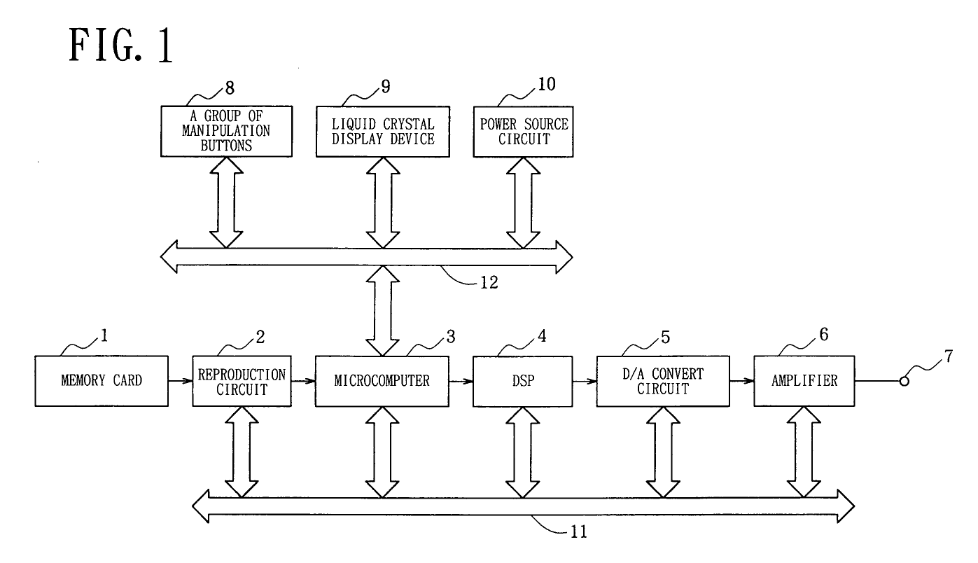

An embodiment of the present invention as applied to a portable audio player shown in FIG. 1 will be described below in detail with reference to the drawings.

A portable audio player of the embodiment shown in FIG. 1 is loadable with a memory card 1. Digital audio data recorded on the memory card 1 is reproduced by a reproduction circuit 2, feeding the reproduced digital audio data via a microcomputer 3 to DSP (Digital Signal Processor) 4. The digital audio data fed to the DSP 4 is given a specified signal processing in the DSP 4, and thereafter the resulting data is input to a D/A convert circuit 5 to convert the data to an analogue audio signal. The analogue audio signal is input to an amplifier circuit 6 to amplify the signal, and to thereafter input the signal through a headphone output terminal 5 to a headphone (not shown) connected to the output terminal 5, outputting the signal as a voice from a speaker of the headphone.

Connected to each other by a first control bus 11 are the reproduction circuit 2, the microcomputer 3, the DSP 4, the D/A convert circuit 5, and the amplifier circuit 6. Connected to the microcomputer 3 through a second control bus 12 are a group of manipulation buttons 8 having a playback button and a stop button, a liquid crystal display device 9 for showing various information, and a power source circuit 10 comprising a secondary cell (not shown) serving as a power source of the audio player.

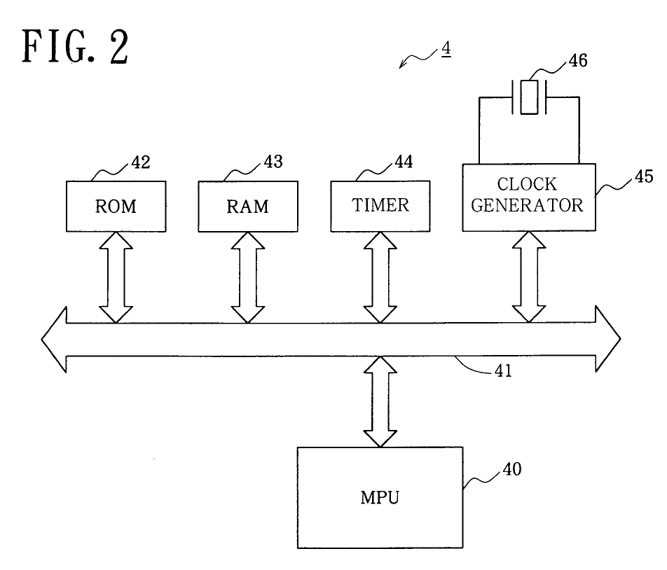

FIG. 2 shows the construction of the DSP 4. The DSP 4 comprises a MPU 40 which has connected thereto a ROM 42, a RAM 43, a timer circuit 44, and a clock generator 45, through a bus 41, as illustrated. The ROM 42 and the RAM 43 each has stored therein a program and data for processing a signal as specified.

The clock generator 45 has a PLL circuit including a frequency divider, and has a resonator 46 connected thereto. The clock generator 45 outputs a clock signal of the frequency obtained by multiplying a frequency of the resonator 46 by a dividing ratio of the frequency divider. The clock signal output from the clock generator 45 is fed to the MPU 40, the ROM 42, the RAM 43, and the timer circuit 44. These circuits 40, 42, 43, 44 each executes a specified operation at a frequency in conformity with the clock signal. Accordingly the DSP 4 performs a specified signal processing at a frequency in conformity with the clock signal.

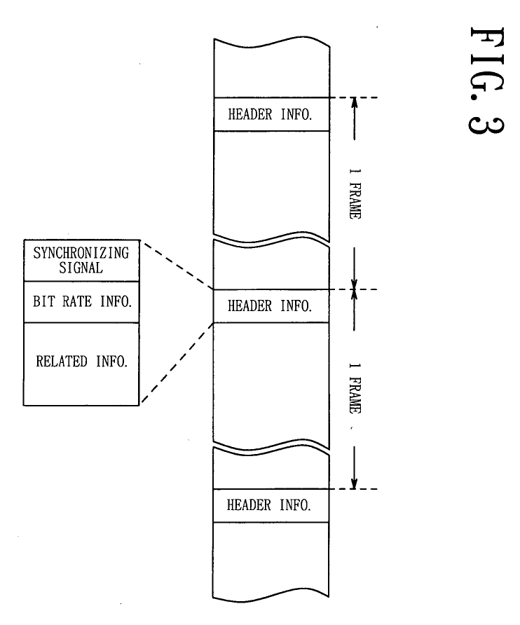

FIG. 3 shows a signal recording format of the memory card 1. Audio data recorded on the memory card 1 includes header information for each frame as illustrated. The header information includes a synchronizing signal, bit rate information representing a bit rate for each frame, and the other related information.

The bit rate of the audio data is in the range of 8 to 300 kbps, for example. Further all of the bit rate information included in audio data providing one tune is not always the same. It is likely that different bit rate information is included in the audio data.

With the audio player of the present embodiment, in reproduction of the audio data, it is possible to vary the operating frequency of the DPS 4 to the optimum value corresponding to the bit rate of the audio data. A memory (not shown) incorporated in the microcomputer 3 shown in FIG. 1 has stored therein a reference value providing reference in varying the operating frequency of the DSP 4 to the optimum value in accordance with the bit rate.

When the reproduction circuit 2 is initiated into operation, the microcomputer 3 starts to inquire whether bit rate information is included in header information of reproduced audio data, and extracts the bit rate information when the inquiry is answered in the affirmative. The extracted bit rate information is compared with the reference value stored in the memory, preparing a frequency control signal based on the comparison result. The optimum operating frequency of the DSP 4 is approximately proportional to the bit rate of the audio data. Therefore when the extracted bit rate information has a value greater than the reference value, the microcomputer 3 prepares a frequency control signal for setting an operating frequency of the DSP 4 to a greater value than the optimum operating frequency when the bit rate is equal to the reference value. On the other hand, when the extracted bit rate information has a value smaller than the reference value, the microcomputer 3 prepares a frequency control signal for setting an operating frequency of the DSP 4 to a smaller value than said optimum operating frequency.

The frequency control signal thus prepared is input to the MPU 40 of the DSP 4 shown in FIG. 2. The MPU 40 outputs a frequency setting command corresponding to the frequency control signal to the clock generator 45 which will set the dividing ratio of the frequency divider to a value in response to the frequency setting command.

In reproduction of audio data, the microcomputer monitors whether the header information of the reproduced audio data includes the bit rate information as described. Every time the bit rate information is extracted, the frequency control signal is fed from the microcomputer 3 to the MPU 40 of the DSP 4. The MPU 40 outputs the frequency setting command corresponding to the frequency control signal to the clock generator 45, setting the dividing ratio of the clock generator 45 to a value in response to the frequency setting command, to thereby vary the frequency of a clock signal output from the clock generator 45 in accordance with the bit rate of the audio data. This varies the operating frequency of the DSP 4 to the optimum value corresponding to the bit rate.

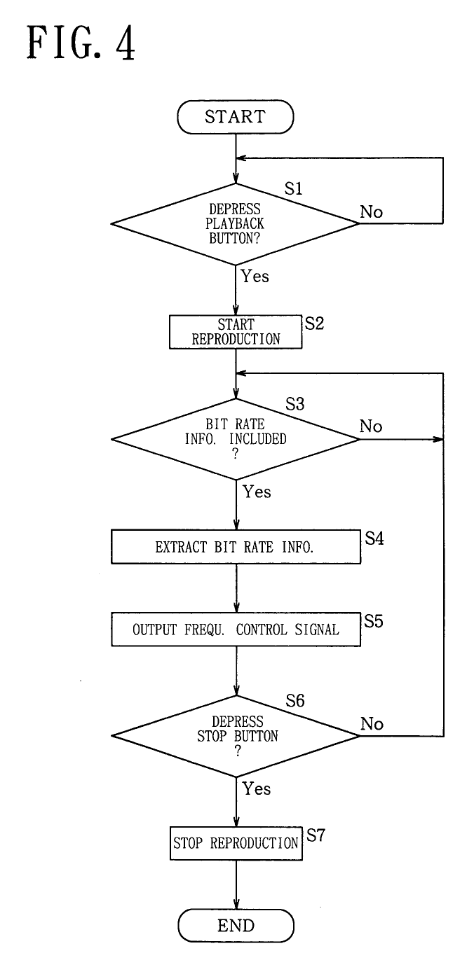

FIG. 4 shows an operating frequency control procedure to be executed by the microcomputer 3 in reproduction of audio data. First in step S1 an inquiry is made as to whether a playback button of a group of manipulation buttons 8 is depressed. When the answer is negative, the same inquiry is repeated in step S1. When the answer is affirmative, step S2 follows to initiate the reproduction circuit 2 into operation.

Subsequently in step S3 an inquiry is made as to whether bit rate information is included in header information of audio data fed from the reproduction circuit 2. When the inquiry is answered in the negative, the same inquiry is repeated in step S3. When the inquiry is answered in the affirmative, step S4 follows to extract the bit rate information from the header information.

Next in step S5 the extracted bit rate information is compared with the reference value stored in the incorporated memory, to prepare a frequency control signal based on the comparison result, feeding the frequency control signal to the DSP 4. As a result the dividing ratio of the clock generator 45 of the DSP 4 is set to the value corresponding to the frequency control signal as stated above.

In step S6 an inquiry is made as to whether a stop button of a group of manipulation buttons 8 is depressed. When the answer is negative, step S3 follows again to inquire whether the bit rate information is included. When the answer is affirmative, step S7 follows to permit the reproduction circuit 2 to cease its operation to complete a sequence of steps.

According to the procedure described, every time the bit rate information included in the reproduced audio data is extracted, the frequency control signal is fed to the DSP 4. As a result the dividing ratio of the clock generator 45 of the DSP 4 is set to the value corresponding to the frequency control signal, varying the frequency of a clock signal output from the clock generator 45 in accordance with the bit rate of the audio data.

With the audio player of the present embodiment, the DSP 4 performs a specified signal processing at the optimum frequency corresponding to the bit rate of the audio data in reproduction of the audio data. Therefore the DSP 4 will not perform a signal processing at an unnecessary high frequency, whereby useless power consumption by the DPS 4 is reduced more than the conventional audio player. This suppresses the shortening of a cell life due to the useless power consumption.

The device of the present invention is not limited to the foregoing embodiments in construction but can be modified variously without departing from the spirit of the invention as set forth in the appended claims.

For example, the invention is applied to an audio player according to the foregoing embodiment, whereas the invention is not limited only to this application but can be embodied as devices for reproducing various digital data including digital image data, etc.

1. A data reproduction device for reproducing digital data recorded on a memory, performing a specified signal processing for the digital data, and outputting the processed data, the data reproduction device comprising;
data reproducing means for reproducing the digital data recorded on the memory,
signal processing means for performing a specified signal processing for the reproduced digital data at an operating speed corresponding to a speed control signal fed from outside and outputting the data,
information extracting means for extracting recording speed information from the reproduced digital data, and
speed control means for preparing the speed control signal based on the extracted recording speed information and feeding the speed control signal to the signal processing means, the speed control means comprising;
storing means for storing a reference value providing reference in preparing the speed control signal as for the recording speed, and
signal preparing means for comparing the extracted recording speed information with the reference value and preparing the speed control signal based on the comparison result.

2. A data reproduction device according to claim 1 wherein as recording speed becomes higher, the speed control means prepares such a speed control signal as makes higher the operating speed of the signal processing means, while as recording speed becomes lower, the speed control means prepares such a speed control signal as makes lower the operating speed of the signal processing means.

3. (Canceled)

4. A data reproduction device according to claim 1 wherein the speed control means comprises;
clock feeding means for feeding a clock signal to the signal processing means, and
commanding means for commanding the clock feeding means to feed a clock signal having a frequency corresponding to the recording speed information.

5. A data reproduction device according to claim 1 wherein the digital data is audio data, and the recording speed information is included in the digital data at a predetermined interval.
